(19) United States
(12) Patent Application Publication
(10) Pub. No.: US 2018/0315025 A1
(43) Pub. Date: Nov. 1, 2018

(54) TECHNOLOGY ADAPTED TO CONFIGURE COMPUTER SYSTEMS TO PERFORM MANAGEMENT, AND ENABLE STREAMLINED USER-CONFIGURATION, OF COMPLEX AUTONOMOUS PEER-TO-PEER TRANSACTION FRAMEWORKS

(71) Applicant: RISKWHIP PTY LTD, Avalon (AU)

(72) Inventor: Ralph McKay, Sydney (AU)

(21) Appl. No.: 15/771,235

(22) PCT Filed: Oct. 31, 2016
(86) PCT No.: PCT/AU2016/051034

§ 371 Date: Apr. 26, 2018

(30) Foreign Application Priority Data
Oct. 29, 2015 (AU) 2015904426
Nov. 24, 2015 (AU) 2015904846
Sep. 30, 2016 (AU) 2016903975

(51) Int. Cl. G06Q 20/06; G06Q 20/22; G06Q 20/10; G06Q 40/08; H04L 29/08

(52) U.S. Cl. CPC G06Q 20/06; G06Q 20/223; H04L 67/1044; G06Q 40/08; G06Q 20/102

(57) ABSTRACT

The present disclosure relates to technology adapted to configure computer systems to perform management, and enable streamlined user-configuration, of complex autonomous peer-to-peer transaction frameworks. Embodiments include computer platforms that enable users to self-generate complex group structures that participate in such autonomous peer-to-peer transaction frameworks, and platforms that enable those frameworks to be autonomously managed on an ongoing basis. Examples are described by reference to a particular practical implementation environment for this form of technology, relating to risk management groups (for instance in the context of crowd funded insurance). However, the underlying computing technology finds broader application. That is, although certain applications of the technology are described by reference to real-world applications in risk management and insurance spaces, it should be appreciated that the core substance of the invention is the underlying computer technology that enables such applications.

### FIELD OF THE INVENTION

The present invention relates to technology adapted to configure computer systems to perform management, and enable streamlined user-configuration, of complex autonomous peer-to-peer transaction frameworks. Embodiments include computer platforms that enable users to self-generate complex group structures that participate in such autonomous peer-to-peer transaction frameworks, and platforms that enable those frameworks to be autonomously managed on an ongoing basis. Examples are described by reference to a particular practical implementation environment for this form of technology, relating to risk management groups (for instance in the context of crowd funded insurance). However, the underlying computing technology finds broader application. That is, although certain applications of the technology are described by reference to real-world applications in risk management and insurance spaces, it should be appreciated that the core substance of the invention is the underlying computer technology that enables such applications.

### BACKGROUND

Any discussion of the background art throughout the specification should in no way be considered as an admission that such art is widely known or forms part of common general knowledge in the field.

Computing technologies and the Internet have seen great advances in the context of providing a level of artificial intelligence and automation to support the manner by which parties interact. For example, “smart contracts” provide computerized transaction protocols that execute terms of a contract.

The advent of smart contracts has provided significant advantages in fields where they have been successfully utilised, however the cost and complexity of developing and implementing smart contracts has generally limited extension of such benefits to the general public. Accordingly, for the general public, peer-to-peer transactions have continued to occur based on traditional contracts (or other agreements that are not necessarily legally binding), and the involvement of technology has been predominately limited to the provision of transaction processing platforms that provide buyer and/or seller protection (for example where electronic payments are held in escrow and/or able to be reversed subject to a dispute management policy). Whilst this form of business-level transaction risk management is arguably sufficient for the majority of straightforward peer-to-peer transactions occurring over the Internet (for example sale of goods), it is not suitable for more complex situations, where access to smart contract technology would be of significant benefit (but based on current technology is generally unfeasible for general public users).

### SUMMARY OF THE INVENTION

It is an object of the present invention to overcome or ameliorate at least one of the disadvantages of the prior art, or to provide a useful alternative.

One embodiment provides a computer system configured to enable streamlined user-configuration of complex autonomous peer-to-peer transaction frameworks, and cause autonomous management of such frameworks, the system including:

a group generation interface that is configured to enable a group controller user to define a new group, wherein the group generation interface is accessed by the group controller user via a user interface rendered at a client terminal operated by the group controller user, wherein defining data representative of the new group includes accessing a rule generation interface thereby to define a plurality of rules;

a rule generation interface that is configured to enable the group controller user to define rules for the new group, wherein rule generation interface is accessed by the group controller user via a user interface rendered at a client terminal operated by the group controller user, wherein the rule generation interface enables the group control user to access, select, and customise a plurality of rule templates thereby to define a plurality of rules, wherein the plurality of rules include:

(i) participation eligibility rules, which define computer-verifiable conditions for a given user to be accepted as a group participant;

(ii) member-to-group payment rules, wherein the member-to-group payment rules define rules for triggering and/or verifying electronic transactions from a given group participant to a defined monitorable electronic funds management service; and

(iii) group-to-member payment rules, wherein the group-to-member payment rules define rules for digitally verifying real-world events, determining payment values, and triggering electronic transactions to a given group participant;

a data management subsystem that is configured to manage a database that maintains records representative of the groups defined via the group generation interface;

an implementation subsystem that is configured to monitor for a set of predefined events defined by the rules, and in response to observance of a given one of the predefined events, trigger a process based on one or more of the rules, wherein the implementation subsystem is configured to provide:

(i) a member-to-group transaction interface that is configured to trigger and verify periodic payments for each group participant to the group in accordance with the member-to-group payment rules for the group; and

(ii) a claim determination interface that is configured to receive, via a user interface accessed by a given participant user, a claim request associated with the given participant user and a group in which that participant user participates, wherein the claim determination interface is configured to cause execution of a claim determination process in respect of the claim request based on the group-to-member payment rules for the associated group.

One embodiment provides a computer implemented method, performed by one or more server devices, configured to enable generation and management of group structures, the method including:

providing a group generation interface that is configured to enable a group controller user to define a new group, wherein the group generation interface is accessed by the group controller user via a user interface rendered at a client terminal operated by the group controller user, wherein defining data representative of the new group includes accessing a rule generation interface thereby to define a plurality of rules including:

(i) participation eligibility rules;

(ii) member-to-group payment rules; and

(iii) group-to-member payment rules;

updating a database to maintain a record representative of the new group;

providing a group access interface that is configured to enable a participant user to view data representative of a plurality of groups defined by group controller users, and selectively provide a participation request associated with selected one of the groups, wherein the group access interface is accessed by the participant user via a user interface rendered at a client terminal operated by the participant user;

operating a participation approval module that is configured to process a plurality of participation requests from participant users, wherein each participation request is associated with: (i) a particular participant user associated with a unique participant user record; and (ii) a particular group; and wherein the participation approval module is configured to make an approval determination for a given participation request based upon processing of the participant user record associated with the particular user and the participation eligibility rules for the particular group;

providing member-to-group payment interface that is configured to enable a given participant user to, following a positive approval determination, provide electronic payment in consideration for participation in accordance with the member-to-group payment rules for the group in respect of which the positive approval determination is made; and

providing a claim determination interface that is configured to receive, via a user interface accessed by a given participant user, a claim request associated with the given participant user and a group in which that participant user participates, wherein the claim determination interface is configured to perform a claim determination process in respect of the claim request based on the group-to-member payment rules for the associated group.

One embodiment provides a computer program product for performing a method as described herein.

One embodiment provides a non-transitory carrier medium for carrying computer executable code that, when executed on a processor, causes the processor to perform a method as described herein.

One embodiment provides a system configured for performing a method as described herein.

Reference throughout this specification to “one embodiment”, “some embodiments” or “an embodiment” means that a particular feature, structure or characteristic described in connection with the embodiment is included in at least one embodiment of the present invention. Thus, appearances of the phrases “in one embodiment”, “in some embodiments” or “in an embodiment” in various places throughout this specification are not necessarily all referring to the same embodiment, but may. Furthermore, the particular features, structures or characteristics may be combined in any suitable manner, as would be apparent to one of ordinary skill in the art from this disclosure, in one or more embodiments.

As used herein, unless otherwise specified the use of the ordinal adjectives “first”, “second”, “third”, etc., to describe a common object, merely indicate that different instances of like objects are being referred to, and are not intended to imply that the objects so described must be in a given sequence, either temporally, spatially, in ranking, or in any other manner.

In the claims below and the description herein, any one of the terms comprising, comprised of or which comprises is an open term that means including at least the elements/features that follow, but not excluding others. Thus, the term comprising, when used in the claims, should not be interpreted as being limitative to the means or elements or steps listed thereafter. For example, the scope of the expression a device comprising A and B should not be limited to devices consisting only of elements A and B. Any one of the terms including or which includes or that includes as used herein is also an open term that also means including at least the elements/features that follow the term, but not excluding others. Thus, including is synonymous with and means comprising.

As used herein, the term “exemplary” is used in the sense of providing examples, as opposed to indicating quality. That is, an “exemplary embodiment” is an embodiment provided as an example, as opposed to necessarily being an embodiment of exemplary quality.

### BRIEF DESCRIPTION OF THE DRAWINGS

Embodiments of the invention will now be described, by way of example only, with reference to the accompanying drawings in which:

FIG. 1 schematically illustrates a framework according to one embodiment.

FIG. 2 illustrates a method according to one embodiment.

FIG. 3 illustrates a client-server framework leveraged by various embodiments.

### DETAILED DESCRIPTION

The present invention relates to technology adapted to configure computer systems to perform management, and enable streamlined user-configuration, of complex autonomous peer-to-peer transaction frameworks. Embodiments include computer platforms that enable users to self-generate complex group structures that participate in such autonomous peer-to-peer transaction frameworks, and platforms that enable those frameworks to be autonomously managed on an ongoing basis. Examples are described by reference to a particular practical implementation environment for this form of technology, relating to risk management groups (for instance in the context of crowd funded insurance). However, the underlying computing technology finds broader application. That is, although certain applications of the technology are described by reference to real-world applications in risk management and insurance spaces, it should be appreciated that the core substance of the invention is the underlying computer technology that enables such applications.

### Overview

Some embodiments relate to computer implemented frameworks and methodologies that enable user generation and management of groups, for example thereby to enable user-generation of autonomous smart contracts, which are executed by a central processing platform. Examples are directed primarily to an implementation environment that include a complex peer-to-peer transaction arrangement, for example where participants configure automated transacting of electronic funds which are attributed to a centrally managed claim fund, with rules defined to enable automated allocation/distribution of available funds to a subset of participants, for instance based on rules that define processes for approving/rejecting claim requests, and rules that cause automated triggering of sub-processes for transaction approval and/or quantification. In this regard, the technology described below provides an intelligent computer platform that allows for user generation of smart contracts, which execute autonomously based on their respective defined rules and protocols. This allows for a wide range of complex peer-to-peer transaction frameworks to be implemented in an efficient manner, whilst avoiding traditional development overheads associated with configuring such frameworks.

Whilst the underlying technology described herein finds a broad range of applications across various peer-to-peer transaction environments, embodiments are described by reference to a specific example whereby a server-based platform is configured to enable end-users to coordinate autonomous smart contracts for situations where all participants transact into a peer-to-peer transaction framework, buy only a subset of participants necessarily transact out of that framework. For example, embodiments are described by reference to risk-related products, with a common category of risk-related products being insurance. In such a practical situation, a relatively low likelihood of claims occurring enables a claim fund defined by modest payments from all participants to cover significantly higher payouts to a small number of participants. However, it should be appreciated that the frameworks and methodologies are not limited to any particular category transaction framework or risk-related product. Rather, the technology (for example computer platforms, technology frameworks, and computer implemented methods) described herein are, at least in some embodiments, adapted to enable users to develop various forms of peer-to-peer transaction frameworks and/or risk-related products, which may extend to forms that were not known or possible in absence of the underling technology.

In general terms, the technology is configured to provide a convenient online process whereby a plurality of users are able to collaborate with minimal central organisational overheads. Users are enabled to generate their own groups with desired smart contract characteristics (for example rules relating to participation, transactions, payments, and claims), and make those groups available for participation by other users who access an online interface (for example via a website or other software platform).

Generation of groups is facilitated by the provision of a group generation interface, which allows a user operating in a group controller user capacity to define parameters a new group, these parameters including rules and/or settings that are used to configure an autonomously executable smart contract. For example, a rule generation interface is configured to enable the group controller user to define rules for the new group via a user interface rendered at a client terminal operated by the group controller user. The rule generation interface enables the group control user to access, select, and customise a plurality of rule templates thereby to define a plurality of rules.

Once the new group is finalised, it may be discovered by other users who use a browse/search functionality to identify groups meeting their own needs. Those users selectively request participation.

In a preferred embodiment, the rule generation interface causes the user to select (and optionally customise) rules for a defined set of smart contract artefacts. There are three key main categories of rules:
Participation eligibility rules. These define whether or not a given user is to be approved for participation in a group, and parameters upon which such participation is able to be approved. These preferably define computer-verifiable conditions for a given user to be accepted as a group participant (for example ID verification requirements, Know Your Customer verification, access to transaction technology interfaces, and so on).
Member-to-group payment rules (for transaction into a group). These define rules relating to consideration for participation in a group. The member-to-group payment rules define rules for triggering and/or verifying electronic transactions from a given group participant to a defined monitorable electronic funds management service (for example a banking account, a payment management service with fund receiving functionality, and so on) This may relate to the likes of consideration amounts, payment types (for example forms of computer verifiable payments), payment schedules (for example forms of verifiable periodic automated payments), consideration value determination, and so on.
Group-to-member payment rules. The group-to-member payment rules define rules for digitally verifying real-world events (for example input data requirements and approval protocols), determining payment values, and triggering electronic transactions to a given group participant. These relate to conditions upon which a participant in a group is awarded a payment, and how that payment is determined. For example, this may include data describing: (i) an event that gives rise to a payment; (ii) a process for determining whether a payment is to be approved (which optionally include approval protocols that require input from one or more further participants); and (iii) a process for determining a payment amount.

These categories of rules enable key phases of a computer-implemented method that provides autonomous implementation of what can be regarded as “smart contracts”, including processing of participation requests, coordination of member-to-group payments, and processing of claim requests. In a preferred embodiment, the rules generation interface presents predefined template rules for each of the above three rule categories, and these are customised by the user.

A user operating a capacity as a “group controller user” configures rules belonging to each category, for example using a set of template rules and/or a user interface delivered rule configuration process. This results in a set of group data, which is stored into a database The group controller user then publishes the group, which transitions the group data into a “published” state, such that other users (operating in a capacity as “participant users”) are able to review, via a user interface, data describing the group based on its configured rules. Participant users selectively place participation requests, which are determined in accordance with the defined participation eligibility rules.

For the purposes of the present description of embodiments, participation is described by reference to “participation units”. That is, a participation user making a participation request for a particular group requests allocation of one or more “participation units” in the group (in some cases the participation eligibility rules limit each participant user to a single participation unit). Upon a positive determination of a participation request, a repository of group record data is updated such that the requesting user is associated with one or more participation units.

In some cases, all participation units in a group are defined equally (for example they have the same price and claim attributes). However, this is not necessarily the case. For example, in some embodiments multiple varied forms of participation units are defined for a single group (for example, in the context of insurance, participation units for car insurance and for home/contents insurance). Furthermore, participation units and/or claim attributes may be defined in a manner personalised to a given user's particular circumstances (for example car type, house value, and so on).

Participant users provide, preferably at the time of placing a participation request, a payment (or approval for later payment) based on the member-to-group payment rules. Upon a set of threshold participation conditions being met (for example a minimum or maximum number of participants), and optionally further conditions such as timing conditions, the group transitions into an “active” state. Based on payments provided in accordance with the member-to-group payment rules, the group record data is updated to maintain data representative of a group claim fund. This is, for example, defined by a value corresponding to a proportion of the total value of payments provided in accordance with the member-to-group payment rules. In preferred embodiments, a member-to-group transaction interface is configured to trigger and verify periodic payments for each group participant to the group in accordance with the member-to-group payment rules for the group. For example, each participant provides pre-authorisation for recurrent transactions, and the member-to-group transaction interface periodically causes triggering of those transactions.

Whilst in the active state, participant users associated with respective participation units are enabled to interact with a user interface thereby to submit claim requests, which are received by a claim determination interface and determined in accordance with the group-to-member payment rules. Approved claim requests result in group-to-member payments, which diminish the value associated with the group claim fund. In some cases the group-to-member payment rules define a protocol that is applied in the case that a total in values associated with approved claim requests exceeds the initial value associated with the group claim fund (as described in more detail further below) or funds or expected to be available to settle valid claims.

In this regard, what is provided is a computer implemented framework that enables a user-generation of groups having defined characteristics, and computer-assisted downstream implementation of those groups in the context of participant approval, collection of funds to define a group claim fund, and distribution of that group claim funds based on claim requests. The defined rules are autonomously triggered based on computer-identification of events associated with those rules, and analysis of data relevant to rule execution. This provides functionality to implement a form of smart contract generation system, specifically tailored to enable complex peer-to-peer transaction frameworks whereby a complex relationship between incoming and outgoing transactions are managed based on rules, including template defined rules.

As context, an exemplary application for the technology is in the context of creating a community insurance policy. A group controller user defines a new group based on rules for participation eligibility, payment, and claiming. Member-to-group payments received from participant users allocated participation units provides a fund to cover insurance claims submitted by a subset of those participant users. This is in broad terms similar in practice to the usual mechanism of standard insurance, however the availability of the underlying computer framework allows the end users to secure insurance without a need to engage a profit-driven insurance service provider.

### Exemplary Framework

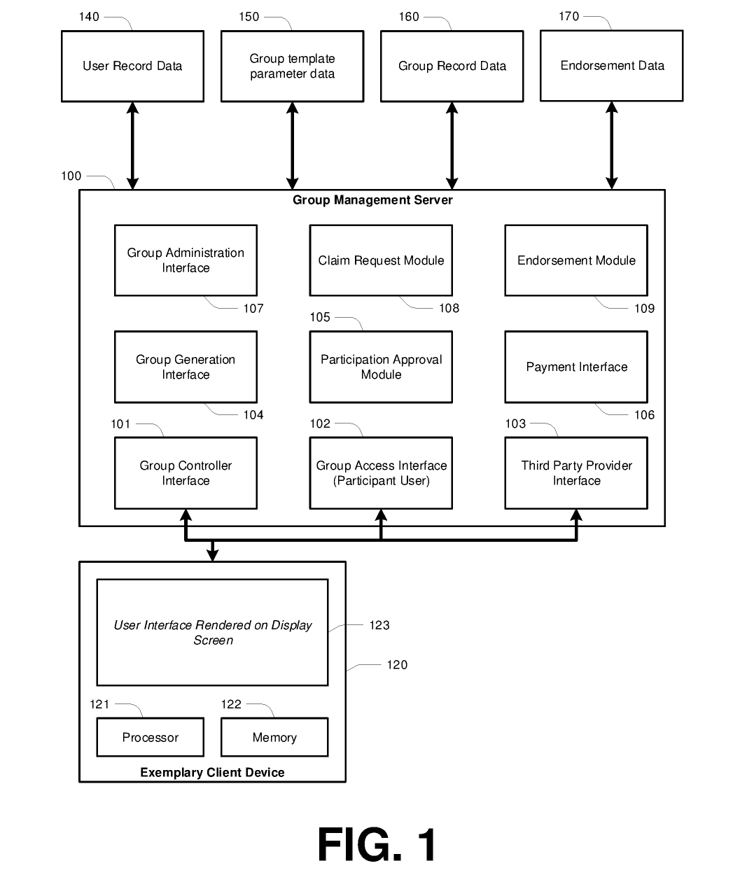

FIG. 1 illustrates a framework according to one embodiment. Components illustrated in this diagram (such as interfaces and modules) are not representative of individual distinct software programs; rather the framework is described by reference to functionally identifiable components, which in various embodiments are delivered collectively via one or more software applications.

A group manager server 100 is configured to interact with a plurality of client devices, including an exemplary client device 120, which is intended to be generically representative of substantially any form of client device. The client devices may include substantially any computing devices, including desktop computers, laptop computers, tablets, smartphones, gaming devices, and the like. The client devices each execute respective software applications that enable the local rendering of user interface components which facilitate interaction between a local user and server 100. For example, client devices may provide such user interface components via: (i) a web browser application, which is configured to download user interface components from one or more web servers, and render those to provide the user interface components; or (ii) a proprietary locally executing software application (such as a mobile app operating on iOS or Android) which is inherently adapted to maintain a communication channel with server 100. Client device 120 includes a processor 121 configured to execute software instructions maintained in a memory unit 122 (for example software instructions representing a web browser application or a proprietary locally executing software application), thereby to render a user interface on a display screen 123.

A user of client device 120 interacts with server 120 thereby to login via a defined user account (and, where relevant define a new user account). For example, each user is associated with a username and password, along with other personalising information. This is maintained in a repository of user record data 140. A given user is notionally enabled to operate in two distinct capacities: (i) as a participant user, which is relevant to functionalities such as browsing available groups, providing participation requests, and providing claim requests, made available via a group access interface 102; and (ii) as a group controller user, which is relevant to functionalities such as group generation and group management, made available via a group controller interface 101. In some embodiments a user is also enabled to adopt a role as a third party service provider via a third party provider interface 103, as discussed further below.

A group generation interface 104 is accessed via group controller interface 101. The group generation interface enables a user of a client terminal, such as client terminal 120, to define a new group, which is a process including defining data representative of that group in group record data 160. Defining data representative of the new group includes accessing a rule generation interface thereby to define a plurality of rules including:
(i) participation eligibility rules;
(ii) member-to-group payment rules; and
(iii) group-to-member payment rules;

In this embodiment, the rules are defined by way of configuring rule templates defined in group template parameter data 150. This template data may include other parameters and/or partially pre-configured group data. The template data may include a plurality of group templates, each template comprising a description, parameters, and plurality of pre-configured rules. For example, a user performs a search based on a desired form of group (for example, a particular form of insurance) thereby to identify a suitable template to use as a starting point. In some embodiments interface 104 provides a “wizard” type interface, which guides a group controller through an interactive “prompt and response” process thereby to systematically select and configure appropriate rules based on user input.

The group controller interface also provides access to a group administration interface 107. In some embodiments multiple users are granted controller level permissions for a given group, and are as such enabled to access data relating to that group via interface 107. Interface 107 enables a user to (i) view current status information for a group; (ii) perform manual processes relevant to participation and claim requests; and (iii) perform other administrator level actions.

Group access interface 102 enables users to search and/or browse groups defined in group record data 160, including groups in a published state that are configured to accept participation requests (in some cases these are filtered on a user-by-user basis based on automated identification of certain eligibility requirements), and groups in which the user is participating (i.e. groups in which the user is associated with one or more participation units).

A participation approval module 105 is configured for handling participation requests. This may include preventing a user from making such a request if certain eligibility requirements are not met based on analysis of user record data 140. The approval process may require submission of additional information (including payment information) and as discussed further below may be tied to operation of an endorsement module 109 which enables user-user endorsement.

A claim request module 108 is configured to process claims based on the group-to-member payment rules for a given group. In some embodiments, each group is associated with a claim form that is completed via a user interface rendered at a client device, and this may be either a predefined claim form or a claim form defined based on the group-to-member payment rules. Those rules also define a process for claim approvals, which may include manual and/or threshold community approval procedures, which are coordinated by module 108.

A payment interface 106 is configured to enable member-to-group payments (for example using credit cards and/or other forms of electronic payments. In some embodiments this include configuration of automated periodic payments.

### Exemplary Method

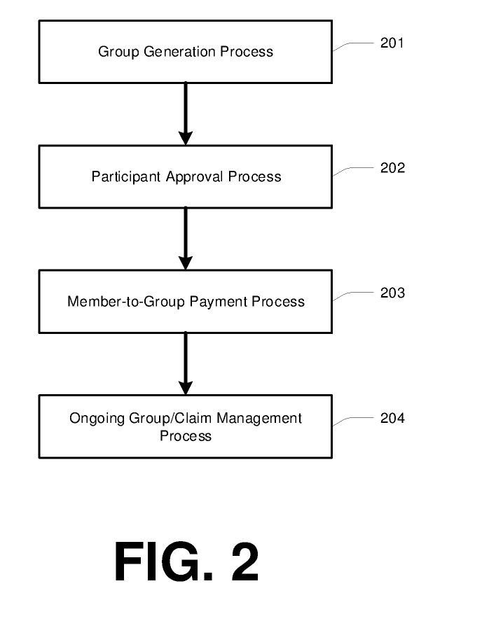

FIG. 2A illustrates a method according to one embodiment.

Block 201 represents a group generation process, whereby a group controller user defines rules for a group via data stored in repository 150, for example by selecting and customising a group template. Data representative of the new group is stored in repository 160. At the completion of the group generation process, the group is set to an active state such that other users are able to identify and review the group (and its rules) and selectively submit data representative of participation requests to request one or more participation units.

Block 202 represents a part approval process, which operates based on participation eligibility rules defined for the group. For example, eligibility may be based upon personal information, and endorsement criteria. Approved participants engage in a member-to-group payment process represented by block 203 thereby to provide consideration for one or more participation units based on the member-to-group payment rules.

Block 204 represents an ongoing group/claim management process. For example, this includes the receipt of data representing claim requests from participant users, and the processing of those requests based on group-to-member payment rules for the group. This may include automated coordination of a process including one or more manual steps (for example delivery of data to a claims assessor, and policing for a response from the claims assessor).

### Details of Exemplary Functionalities, Rules and Rule Types

Described below are exemplary functionalities, rules and rule types present in various embodiments. For example, these are in some cases delivered via the framework of FIG. 1. These are described by reference to “risk groups”, being a subcategory of groups that are able to be defined, these being defined for the purpose of enabling a group of users to collectively manage a defined form of risk.

### Overview of Example Rules

Described below are a range of example rules able to be configured via the rule generation interface according to various embodiments. In various examples below, a description of the operation of rules is provided. It should be appreciated that, for each of these, the rule generation interface provides access to a template rule having that operation, and the interface is configured to allow customisation of that rule for a current template. That customisation may include either or both of: (i) automated customisation, where rule parameters are set by reference to known group data and/or other defined rules; and (ii) user customisation, whereby a user selects between user-controllable parameters and/or implementation options.

By way of example, the process of defining rules via the rule generation interface includes presenting a group controller user, via the user interface, with a rule category, and enabling the user to select and optionally customise one or more rules within that category. For example, the user selects between a “Lookback” Participation Unit Payment Option and a One sided market-driven risk pricing mechanism (these are discussed in detail below). The user is also invited to select optional rules such as rules allowing for Excess Participation Unit Payment Option(also discussed below). For one or more of the selected rules, the user customises a template rule, for example by setting parameters.

### Basic Group Operation Rules

The group generation interface enables setting of basic operating rules, including but not limited to:
Permitted risk types.
The unit of measurement of member-to-group payments and/or group-to member payments (for example in terms of currencies, cryptocurrencies, commodities, services, and the like).
Permitted minimum and maximum payment amounts for participation units and/or claims, participation unit durations, and global risk limits for the risk group.
Permitted payment and claim methods.
Participation unit cost setting formulae/methods.
Permitted classes or group status of risk group members (for example “not authorised to own participation units”, “authorised to own participation units”, “temporarily suspended from activity”).
Risk group global and individual member exposure level limits (for example defined protocols that are applied where claim value exceeds claim fund value).
Geographic constraints for participants and any participation units that reference location(s).
Member joining methods (for example requirement to obtain verification codes from third party sources, etc.).
Membership and participation unit cancellation rules, and penalties for prescribed activities.
Third party re-insurance options to cover risks related to potential short-falls in satisfying claims.
Protocols for claim approval, including utilisation of particular third party claims assessors.

It will be appreciated that this is a representative selection only.

### Group Controller Gatekeepers

In some embodiments, users are required to interact with an online application process thereby to obtain permission to operate as group controllers. In one embodiment, a plurality of gatekeepers users are defined, these each having access to a user interface component which displays pending Group Controller applications. Gatekeepers are enabled to accept/reject or query applications as required. Another user interface component preferably is available to Gatekeepers to display various statics about Group Controllers including the Risk Groups which they have created, or to which they have administrator level access.

Users can in some embodiments also apply for status as re-insurers (a category of third party provider). Thus a user could have all or any of the global status options: Gatekeeper, Group Controller, re-insurer and as well as a Group Status in each Risk Group the user has joined. As discussed below, in some embodiments trustees have a special class of membership.

### Exemplary Participation Eligibility Rules

In some embodiments, a user interface component enables Group Controllers to set criteria by which a first subset of users are approves as being eligible for participation in a given risk group. This may include a manual selection process, and/or a filtering process by which user record data is filtered based on Group Controller defined participation eligibility rules (for example based on age, location, other demographics, prior interactions with the framework, availability of third party identify verification data, and so on). This optionally extends to functionality to automatically open user sign-in accounts. A Group Controller is enabled to assign a status to users, such as “authorised for participation”, “not authorised”, “suspended” etc.

In some embodiments group controllers are also able to provide invitations to join a group by importing lists from external sources (for example using APIs), such as email, third party software such as CRMs, social media platforms, and the like. Invitations may be transmitted by the framework, or through the external source (for example sharing via a social media platform).

In some embodiments, participation eligibility rules include requirements for threshold levels of user-user endorsement as provided by endorsement module 109. For example, an authorised group member (for example a member approved by a Group Controller) is enabled to endorse an existing unauthorized user. Such unauthorised members may require a defined minimum number of endorsements to satisfy participation eligibility rules. The endorsers of each user are recorded in a repository of endorsement data 170. In some embodiments known member-member connections (for example imported from a third party social media platform, from email contact lists, or the like) enables endorsement module 109 to provide electronic notifications to users who are predicted to know (and hence endorse or not endorse) other users in respect of which participation requests are pending.

In some embodiments channel technology enables Risk Controllers to construct and view branches of users emanating from a particular endorsing user via endorsement module 109. For instance, this assists in identifying potential weaknesses in an endorsement chain, and hence automated and/or manual identification of predicted unwanted users (for example false/spam accounts and the like).

### Participation Unit Definitions

Each participation unit includes data fields that fully specify actual or potential cash flows and contract counterparties. This includes specification of its owner (potentially more than one user may own a single participation unit), the purchase cost that is for the participation unit, participation unit start and end dates, the event(s) and conditions that trigger a payout or claim, the allowed methods of payment in respect of the participation unit (and claims), claim validation rules, and optionally other data.

In some embodiments, not all participation units a given Risk Group are identical. For example, participation units may have different start and end dates, different costs (which may be based upon a common cost determination algorithm). Also, in some embodiments a particular class of participation unit may have no end date, such as perpetual insurance for a single finite upfront cost.

### Participation Unit Cost Determination Methods

Member-to-group payment rules define a cost for each participation unit. This cost may be defined by reference to a cost determination method. For example, the group generation process includes configuring rules defining of the manner for determining a fair market value for a participation units (noting that not all units in the same Risk Group need be identical in risk profile, for example in the context of car insurance a risk profile is different for certain models of car or driver ages) in a given Risk Group. Options include: (i) a mathematical formula defined by the Group Controllers, (ii) a formula defined by a Group Member vote, (iii) a rule defined by the history of claims for similar participation units in the same Risk Group or data available from other similar Risk Groups (for example refer to “Consolidated Risk Windows” further below).

### “Lookback” Participation Unit Payment Option

In some embodiments, an available option for member-to-group payment rules includes a rule that defines a portion (from zero to 100 per cent) of a total participant unit cost that can be (or must be) paid in a manner indexed to the total value of actual valid claims recorded in defined time intervals or claims from a defined group of participation units. This causes the system to automatically tally the amount of unpaid claims at the end of each interval (or expiry of the defined group of participation units) and automatically instruct participation unit owners (by various electronic means) to pay their apportioned share of the tally. This method can at times result in a smaller participation unit cost actually paid compared to participation unit costs paid in advance (even when compared to the same discount date). This method can reduce cash flow requirements on users and avoid the need for refunds at times when claims are unexpectedly low.

### Consolidated Risk Windows

In some embodiments, certain users such as Re-insurers, Group Controllers, Group Members (and possibly government agencies/regulators) can be informed about the inherent risks in Risk Groups any participation unit sub-sets of interest using a Consolidated Risk Windows technology. A risk monitoring engine automatically produces consolidated expressions of key risk parameters for each Risk Group and defined sub-group. The consolidated risk expressions are display in a public or secure URL at defined intervals or updated live or sent by other electronic means directly to interested parties in a subscriber list.

Consolidated risk expressions include: the total participation unit cost value with breakdown by total cash received and held, total unpaid participation unit costs, the nature of the risks that trigger claims and total potential claim value all expressed in time buckets to indicate actual and potential cash flows.

### Re-insurers

The group-to-member payment rules preferably define a protocol that is applied where the total in claim payment exceeds (or is anticipated to exceed to a defined probability) the claim fund (derived from member participation unit payments), which may be adjusted for any holding costs and interest on capital to a single valuation date. For example, options include: reducing individual claim amounts to bring the total within budget; requiring members to provide additional individual contributions, or relying on re-insurance to cover a shortfall.

In some embodiments an operational rule allows Group Controllers to invite and accept interest from potential re-insurers. This involves re-insurers accepting the excess claims liability in a defined time interval for a defined sub-set of participation units or all participation units in the Risk Group. Re-insurers receive a re-insurance payment, which may be defined as a proportion of the participation unit cost for each re-insured user.

Excess claims for a defined set of participation units means the difference between the total value of validated claims and the total value of participation unit costs paid or expected to be paid for the same set of participation units, which may be adjusted for any holding costs and interest on capital to a single valuation date. Excess claims represents the shortfall in satisfying all validated Claims for the defined set of participation units.

In some embodiments, another operational rule allows the Risk Group to re-insure other groups within defined risk parameters.

### Securitization

To assist re-insurance and risk transfer mechanisms, in some embodiments participation units can be securitized into bundles defined by “Tag Groups”. A bundle of participation units defines a risk profile which can be constructed legally as a fungible financial instrument. A securitization Operational Rule allows Group Controllers to define all participation units in a Risk Group or defined sub-groups of participation units at a particular time as a uniquely named Risk Bundle. Risk Controllers can then mark selected Risk Bundles as open for securitization offers in a competitive bidding forum. A securitization management system enables Group Controllers to accept securitization offers (re-insurance) and record the Risk Bundle owner.

A splitting tool allows Risk Controllers to offer re-insurers micro units of a securitized bundle. Individual Members with re-insurer status could bid for micro units of the Excess Risk in securitised bundles. The splitting option and the size of micro units is set from the Operational Rules tool. In some embodiments this feature also provides a means for users to underwrite the excess risk of participation units owned by friends/family.

### Claim Validation

Some group-to-member payment rules define permitted claim validation methods. Examples include:
Utilising one or more third party assessors from of a defined list of third parties assessors.
Publication in a defined manner of a defined market event.
Publication in a defined manner of defined natural event.
Publication in a defined manner of defined gaming or entertainment event.
Trust-based claim validation.
Collective option for validating claims, all members or a defined sub-group of members vote to approve/reject all claims or a subset of claims.

Trust-based Claim validation involves a defined minimum number of authorized members confirming electronically the integrity of a user's claim. Member endorsers found to be validating fraudulent Claims (in violation of the Group Membership Rules) can lose their own claim entitlement and be dis-endorsed from the group. This assists in community self-management and self-regulation.

A drawback of conventional insurance is the time, hassle and uncertainty that a given claim will be satisfied as expected. In some configurations, the technology described herein enables near instant payment of a claim. This is particularly true with the trust-based Claim validation Operational Rule and for any Claim validation method that is triggered by an event that can be detected with an online tool, for example publication of a market, gaming or natural event.

The Risk Group's Operational Rule may, in some implementations, require one or more third-party assessors or authorized members to confirm claims electronically. However a claim payment processor technology is optionally configured to transfer payments related to confirmed-as-valid claims immediately or at regular closely separated time intervals into the participation unit owner's account.

### Participation Unit and Claim Payment Methods

In some embodiments rules for the methods of permitted payment of participation unit costs and Claims include transfer of sovereign currencies, cryptocurrencies and delivery of a defined service and defined materials. For example, claims related to agricultural business risk participation units may be satisfied by delivery of a commodity supplied by other members in the same group or re-ensurers.

### Excess Participation Unit Payment Option

In some embodiments, an optional rule enables Group Controllers to enable a defined maximum number of members to pay a participation unit cost that is higher than standard (for example above a determined fair market participation unit cost). This enables the relevant members to reduce the excess claim risk. Excess participation unit costs attract defined returns when the excess participation unit cost is negative (i.e. when funds are available for return to members because claims are lower than expected).

### List Manager Access Tool

In some embodiments, managers of lists owned by professional bodies and member associations may want to offer participation units to their members without wanting to be involved as a Group Controller. This is optionally achieved by way of another class of user that has the ability to upload lists into selected existing Risk Groups chosen from a Risk Groups menu. This is achieved by a user first making a request for List Manager Status which can be granted by the relevant Group Controller(s). These electronically uploaded lists (file upload or copy and paste the list into a box in an online form which is then submitted) are automatically tagged on upload and uniquely named and associated with the uploading List Manager. This requires a second form a tagging tool which associates users (not just participation units) with a particular tagged group (“Tagged Members”). List Managers can then have access to various statistics about their member activities and potentially earn commissions or payments related to Tagged Member activities.

Related to this is the ability to create a different class of participation unit bundle that automatically includes any Participation units owned by Tagged Members associated with the List Manager. List Managers preferably have access to all the same cash flow and risk monitoring tools (related to their Tagged Members) as Group Controllers and also as defined in the Consolidated Risk Windows tool for Participation units.

Participation Unit Bundles with Defined Time Buckets

To assist with securitization and analysis of cash flows and risks in defined time buckets a participation unit bundle option allows the same participation unit to appear in many different bundles (otherwise participation units would all need to end at a small number of defined dates to allow practical bundling). For each participation unit in more than one bundle its participation unit cost and claim or potential claim is apportioned to each bundle it has been assigned. This apportioning is done by computing the total time span that the participation unit can exist in each bundle (bundle time) then forming the ratio of each bundle time to the lifetime of the participation unit. This creates fractions which when adjusted by an appropriate discounting interest rate are used to apportion cash flows and risk measures of the particular participation unit to each Risk Bundle to which it has been assigned.

### Risk Group Member Security Window

In some embodiments risk group members have access to a Member Security Window which lists all or a subset of data recorded for the Risk Group relevant to the claim security of participation units and the probability of valid claim payments being met in a timely fashion. This includes breakdown of all assets held by or in trust for the Risk Group, potential claim amounts and statistics indicating the amount of capital expected to be needed to satisfy claims. Statistics include the number of participation units on issue and valid claims in time buckets over the history of the Risk Group's life including total premiums received and claims paid in each time bucket, the excess claim amount in each time bucket, the number and nature of participation units currently on issue, the expected number of valid claims and total expected claim amount related to the currently issued (and anticipated to be issued) participation claims and risk measures indicating likely dispersion of outcomes around the expected (mean) values.

### Risk Group Member Participation Unit Pricing Tool and Purchase Procedure

In some embodiments Risk Group members have access to an online participation unit pricing tool that produces an instant fair market Premium quote based on the pricing rule defined from the Risk Group's Operational Rules and the member's participation unit's tailored specification. For example, in a Risk Group offering participation units that provide a form of house insurance, a member may use the pricing tool before purchasing a participation unit by inputting into the pricing tool window: the value of their house in a defined currency or form of money as permitted by the Operational Rules, the term of insurance measured in days, hours and seconds, the percentage value to be insured, house location, house construction type selected from a menu (and whatever other variables are defined in Risk Group's Operational Rules Controllers). The pricing tool then immediately displays the Premium as a quote. The member can the click a button to immediately accept the quote (or adjust the inputs before doing so) and proceed to the related participation unit type terms and conditions page for final acceptance. Payment of the Premium would then follow according to the method(s) defined by the Operational Rules. The participation unit, as defined by the member in the pricing tool, is then immediately created and recorded in the database and added for all relevant Tagged Groups.

A fair market premium (pricing) formula for a participation unit can be defined as a mathematical formula using as inputs: the probability on a valid claim occurring; the expected payout amount of a valid claim; and an interest rate or discount rate derived from the term structure of interest rates or equivalent yield curve representation for the relevant currency. In the case where the claim event could occur with equal probability over a time interval the probability can be defined in terms of a probability per unit time interval.

Group controllers are in some embodiments enabled to define Operational Rules which link each pricing tool to one or more specific probability expressions and an interest rate term structure expression for the relevant currency. The Operational Rules allow the user pricing tool to be configured to request one or many data inputs that collectively determine which of the linked probability expressions applies for the premium for the particular participation unit.

One method of determining the probability expression is with a member vote which enables each voter to select their best estimate of the relevant probability from an ordered list of probabilities covering a wide range of potential probabilities, or to invite the voter to input an exact probability. The probability expression is then produced by taking an average or weighted average of the voted probabilities or blending this result with other relevant probability data available.

In the case where each participant unit in a Risk Group relates to a separate event, the sum of the fair market premiums for each participant will not necessarily be sufficient to cover all valid claims but the sum will represent the expected (average) total claim payout. The pricing tool is preferably configured to enable display of the expected probability of partial satisfaction of a valid claim.

Another method of determining probability inputs for use in the pricing tool for a given participation unit type is to ask people to select via an online vote or survey the number of times they experienced a relevant valid claim and the claim amount during a defined period of time in the past or events they experienced in that time period which could have been defined as valid claims had they held the defined participation unit in that period of time.

### Competition Style Participation Units

A particular form of participation unit in some embodiments enabled by the Operational Rules is defined by reference to a specified list of events. All participation units are referenced to the same list of events, and a valid claim for a particular participation unit is defined by way of prediction of the correct order of the list events, as they occurred in time, or a subset of those events. For example, this may be implemented in the context of predicting which competitor came first, or say first, second and third, in a defined game or race with predefined competitors. In this case the pricing tool is configured to produce fair market premiums for each participant unit which ensures that all valid claims are satisfied in full—that is no Excess Claim risk need exist.

### Participation Unit and Excess Claim Risk in the Case of Dynamic Risk Groups

An issue arises in the fair market pricing of a new participation unit when the participation unit is issued at a time when other participation units exist in the same Risk Group but were issued at an earlier time or times and a higher or lower number of valid claims than expected have already occurred. A related pricing issue arises from changes in probability assumptions or relevant interest rates (dynamic pricing parameters). In both cases this means the actual capital held (including capital expected to be received) by the Risk Group, at the time of pricing and issuing a new participation unit, may be more or less than determined as sufficient by the relevant pricing tool when accounting for all outstanding participation units and any unpaid valid claims. The calculation of this excess capital (positive or negative) in the Risk Group requires the dynamic pricing parameters to be adjustable automatically (based on data feed in) or adjusted manually by a Group Controller at regular and preferably short intervals in time to allow a mark-to-market style recalculation of the Risk Group's fair market capital requirement which can then be compared with the Risk Group's actual capital held. “Mark-to-market” here means the Risk Group's fair market capital requirement is recalculated live or at regular time intervals or immediately before the pricing tool is used. This is achieved with an integrated software module which takes as input all data relevant to the re-pricing of all current participant units in the Risk Group. It then automatically uses the assigned pricing tool to re-price each participation unit and sums the re-calculated premium (cost, value) of each participant unit in the Risk Group to produce a net value being the contemporaneous fair market capital value for the Risk Group. The excess capital is calculated as the different between the fair market capital value and the actual capital held. This contemporaneous excess capital is then mathematically apportioned fairly across all current participant units in the Risk Group (or all PUs plus one) to produce an adjustment value that if applied to each participation unit would result in zero excess capital for the Risk Group at that time. This unit adjustment value can be used to adjust the premium determined by the pricing tool for a new participation unit or otherwise recorded to enable a fairer apportioning of risk and or capital, by some other means, than would otherwise be possible.

### Template Makers and Access Menu

In some embodiments, a further status for a user is as a “Template Maker”. These members have access to tools for defining new types of participation units all recorded in a template database. Group Controllers can view existing templates in a menu tree and select particular templates for use in their Risk Group(s). This not only makes it very easy for Group Controllers to populate their groups with authorised types of participation units but also creates any opportunity to offer a standardized specification of participation unit to members. The standardization opportunities assist with comparison of risk statistics across Risk Groups. It also facilitates a process of bundling of Tagged Groups (bundles of bundles) across different Risk Groups which can be useful for securitization applications.

### Automatic Warning and Protection Against Sudden Excessive Claim Payouts

Another software module monitors, at regular intervals such as daily or more frequently, the frequency of claims and valid claims against an expected frequency as determined from the assigned probability assumptions and also monitors the Excess Capital (as produced by the marked-to-market module) as a ratio of total capital held. When variations from expected exceed a tolerance defined in the Risk Groups Operational Rules then the Group Controllers and possibly Gatekeepers are alerted automatically. Another Operational Rule enables all automatic validation of claims to be delayed pending investigation at these times.

### Methods for Immunising Risk Groups Prone to High Volatility in Claim Probabilities

Certain types of participation units have higher exposure to a risk that a large percentage of users are exposed to the same often rare event. This can result in excessive premiums required to be paid for participation units to compensate for the high payout risk or the inability for the Risk Group to satisfy a large percentage of valid claims in the event that many claims are made in a short time interval. An example is participation units providing compensation for property damage in the event of a natural disaster such as earth quake, storm and fire. Risk Group's offering participation units that intend to compensate users for say, earth quake damage, can reduce the risk that an excessive number of valid claims are received following from a single earth quake by including participation units from geographically dispersed regions in the Group. A software module enables Group Controllers to search for other Risk Groups which specialise in similar risk types but with the desired risk diversification qualities and then view a list of Risk Groups matching the search criteria and the ability to click to initiate communication with selected Group Controllers. An Operational Rule provides Group Controllers with the option to send merger requests to other Risk Groups and to accept merger risks—which causes all the relevant data from the two Groups to be copied automatically into a new Risk Group with a name defined by the merging parties. Another Operational Rule enabled Group Controllers to cross-insure with other Risk Groups which means both Risk Groups maintain their separate identities but electronically agreed to a risk sharing agreement, which may be selected from a system provided template. Here “cross-insure” means the Risk Groups which are party to the agreement agreed to a formula for assisting each other financially in the event of a funding short-fall by either group in meeting valid claims. The Operational Rules provide a list of template cross-insurance formulae. For example a Risk Group would typically not wish to insure a Group larger than itself but rather a matching portion of the larger Group's risk.

### Allocating Group Funds Available for Valid Claims to Time Buckets

Particularly in the case of participation units which can produce valid claims at any time or semi-continuously, there can be a disincentive for users to purchase longer term participation units because of a possible perception that an excessive drain on the Risk Group's funds could occur before the longer term participation unit expires. A method to manage this risk is an Operational Rule which allocates the premium paid (or expected to be paid) for each participation unit to be apportioned (and adjusted for relevant discount rates) to short term time buckets covering the life of the participation unit. This Operational Rule causes only the funds allocated to each time bucket to be available for satisfying valid claims received in the same time bucket. In the event that not all allocated funds are paid out in any time bucket period the remaining funds can be carried forward into the next time bucket and so forth. The duration of the time bucket is also set by an Operational Rule.

### Secondary Market in Participant Units

Particular types of participant units could be suitable, at times, for re-selling to other users. An example could be a participation unit which defines a valid claim if a defined weather event occurs in a defined region in a defined time period. The owner of such a participation unit may experience a change in circumstances and no longer require the risk/reward profile that the participation unit provides and therefore wish to sell it. An Operation Rule allows Group Controllers to select a switch associated with selected participation unit types which provides owners of the same types of participation units with a reseller/ secondary market tool. This reseller tool includes a click method that enables users to define selected participation units they currently own as offered for sale which then causes them to appear in a list in a “for sale” window visible to all Risk Group users. The for sale list displays details of participation units offered for resale and displays the current market price, as determined by the relevant pricing tool, for each participation unit in the for sale list. The for sale window also provides a facility for users to enter their offer prices and the duration of the offers and records the offer data in the database and also displays the offers for other users to see. At any time prior to expiry of an offer and provided the participation unit has not expired and provided it has not been the subject of a valid claim the owner of the unit may accept a valid offer with a click and confirm page which then causes the interested buyer to be notified automatically, prompted for payment and provided with a means to make the payment, and on making the payment ownership of the participation unit is automatically transferred to the new owner. The seller is immediately informed electronically of the sale and funds credited to the sellers account.

### Method of Enabling Users to Purchase Higher Ranking Participation Units in the Event of a Payout Shortfall

An Operational Rule defines how funds are to be used in the event of a shortfall of funds in satisfying valid claims. Various options can be included. Such as 1. The option to apportion the available funds across all unpaid valid claims in a manner that causes the same percentage of each valid claim to be satisfied. 2. The option to payout valid claims to a predefined percentage of the total claim and according to a defined ranking order and also enabling users to view the current ranking of each participation unit they hold, relative to all participation units in the Risk Group, in defined time buckets over the life of the participation unit along with a statistic indicating the expected percentage payout at the assigned ranking and also for a range of other rankings. Users have access to a ranking booster tool which allows them to nominate a possible additional payment amount to which the booster tool responds with the new ranking statistics in event the nominated payment is made immediately and provides a click method for agreeing to pay the nominated amount and for making the payment. This tool not only allows users competitive control over the payout ranking of their participation units but also adds to the overall Risk Group's security by increasing funds held by the Group without changing the overall payout risk.

### A Special Risk Group for Risk Groups

A special class of user has Group Controller access to a Risk Group which has its members other Risk Groups only which are admitted either automatically or on request by a Risk Group Controller. The members of this Risk Group for Risk Group have access to a special type of participation unit which has a valid claim event defined to represent a catastrophic short fall of funds in the Risk Group that owns the participation unit. The Risk Controllers of the member Risk Groups have access to a pricing tool which is used to price the participation units according to a formula which accesses the risk of failure of each Risk Group. A payment facility enables Group Controllers of the different Risk Groups to authorize payments into the special Risk Group's fund from time to time for the purchase of participation units. These participation units function as a form of failure minimisation protection for their Risk Group owners—that is, a convenient and methodical way for the Risk Groups collectively to re-insure each other without the use of third party re-insurers.

### Market Style Competitive Processes for Setting Participation Unit Premiums

A number of operational rules allow the use of a market style determination of the premiums paid for defined groups of participation units. An Operational Rule enables the critical pricing tool variables or actual minimum sale price for all new participation units or for a defined group of participation units to be determined by a vote from Risk Group members or a portion of members. Another Operation Rule allows Risk Controllers to limit the maximum number of participation units that can be sold in selected time buckets. Another Operational Rule enables selected groups of new participation units to be underwritten by re-insures who bid to accept the Excess Risk in each participation unit or defined parcels of participation units and receive a defined percentage of the premium that the Risk Group receives from each such participation unit.

### Enabling Group Structure Merging via Time Buckets

As noted above, various embodiments provide a group generation interface that is configured to enable accessing of a rule generation interface thereby to define a plurality of rules including for a group. These rules include:
(i) participation eligibility rules;
(ii) member-to-group payment rules; and
(iii) group-to-member payment rules;
(iv) risk participation unit specification details

In some embodiments, rules such as payment rules (group-to-member and/or member-to-group) are associated with timing parameters. As described below, some embodiments make use of a concept referred to herein as “time buckets”. Time buckets are defined by divisions in a timeline. The period of time between two adjacent divisions defines a single bucket. A time bucket is in essence a defined time period to which a particular set of data is assigned. For example, funds received (or pledged) from group members are assigned to specified time buckets, and the funds in a particular bucket are used to satisfy individual claims linked to the same time bucket. So, for example, the group rules configure a risk-related group whereby each use makes a defined contribution to an “August” time bucket, and that time bucket is available to satisfy risk event claims occurring in August.

In some embodiments, the concept of time buckets is implemented such that certain forms of data (such as funds data) is assigned to specific time buckets, and once assigned to a bucket the data must remain in the same time bucket. In a flexible implementation that allows users control over defining of time bucket parameters (for example length, start days, and so on) when defining group rules, there are challenges associated with allowing for the merging of multiple groups with different time bucket parameters. For instance, there exists different data sets which are managed independently which may in the future benefit from using identical buckets or require merging into a single data set, and there is a desire or need to minimize the number of different durations used in each data set.

The time bucket management technology described below provides two key advantages. First, it increases the probability of achieving bucket alignment across different data sets by using consistent rules for defining the buckets in all data sets. Second, it defines an efficient process for enabling a data set which is continuing to add new time buckets for new data to transition to a different bucket duration so as to achieve bucket alignment with a different data set in a manner that avoids the need for any inconsistent duration “transition” buckets.

An example of a practical application of this invention is with risk-pools, consisting of groups of people or entities participating in individual-to-group risk contracts where funds received or pledged from group members are assigned to one or more time buckets and those funds must be used to satisfy individual claims linked to the same time buckets. In this case different groups may sometimes wish to combine resources for the purpose of satisfying claims. Alignment of the time buckets in the combining groups is a pre-condition for combining resources across the different groups. In this case there is also likely to be an advantage or requirement to restrict the bucket durations to defined values and to minimize the number of different bucket durations used in any group.

The time bucket management technology provides a set of computer-enforced rules. A first rule, referred to herein as “Rule 1”, requires bucket divisions for all data sets to use a common precise start time, called the “base time”. Rule 1 means that all data sets consistently using the same bucket duration will automatically be using buckets with perfectly aligned divisions. A second rule, “Rule 2”, enforces that permitted bucket durations are restricted to values which ensure that all possible bucket durations, other than the smallest permitted duration, are integer multiples of any smaller permitted bucket durations. Rule 2 means it will always be possible to transition to a different bucket duration without the need for a third “transition” duration bucket. For example an allowed set of durations under Rule 2 is: 1 day, 7 days, 14 days, 28 days. In this case for all bucket series that also satisfy Rule 1 the longer duration bucket divisions will overlap with smaller duration bucket divisions.

For two different groups currently using different bucket durations there are two possible ways to align the bucket durations of the two groups in the future:
(i) The group currently using longer term buckets can reset the duration of all newly formed buckets, before new data is assigned, to be the same as the duration of the group using the smaller duration buckets—the newly formed buckets will automatically align as a consequence of using Rules 1 and 2.
(ii) The group using smaller duration buckets can transition to the larger duration. In this case, the last division of the last bucket created will not necessarily coincide with the start of a longer term duration bucket. In this case the system is configured to apply an algorithm thereby to create a minimum number of additional buckets of the existing smaller duration such that the last division of the last smaller duration bucket coincides with a division of the required longer duration bucket. This number of additional buckets may be zero or at most one less than the number of smaller buckets that fit into one larger bucket.

Rules 1 and 2 ensure that a transition point will exist and is achieved efficiently. In particular, where:

t=time of last short duration bucket division;

d=length of smaller bucket duration; and

D=length of longer bucket duration;

t, d and D are all expressed in the same dimension of time.

Rules 1 and 2 ensure that t/d must be an integer multiple of D/d. Therefore, the additional number of smaller buckets N required is given by:

Let n={[INT(t/D)+1]×D}−t

N=n/d except if N=D/d then set N=0

It will be appreciated that the ability to restrain group creation based on time bucket parameter limitations using Rules 1 and Rules 2 provides for a flexible customisable framework which nevertheless enables streamlined group merging.

### One Sided Market-Driven Risk Pricing Mechanism

As noted above, various embodiments implement technological approaches that enable defining of pricing for participation in risk-related groups. Described below is an approach for discovery of fair market pricing that makes use of a one-sided market-driven pricing mechanism. It should be appreciated that this mechanism finds broader application outside of the described technological frameworks for group structure implementation.

Generally, the fair market price for services or goods can only be known when many buyers and sellers have access to a mechanism that facilitates transparency in bid/ask prices and actual transaction prices. Here “fair market” is defined as a price that does not readily offer risk-free arbitrage opportunities to either the buyer or seller. The existence of both buyers and sellers competing for the best price is in general a fundamental requirement in the fair price discovery process. There are inherent challenges where only one side of the market exists; without buyers and sellers competing there is no market-driven fair price discovery mechanism. The mechanism of one embodiment enables participants in a one-sided market to enter into contracts defining a specific service or goods at a self-assessed price prior to receiving verification of a fair market price. At a defined future time when the actual fair market price is transparent, the contract holders are required to pay for the service or goods. Holders of contracts which defined off-market prices (that is prices higher or lower than fair market) are penalized. The penalty could be defined in various ways—for instance the risk of missing out on part or all of the service or goods delivered, or paying a premium over the market price. The penalty is indexed in a defined manner to the magnitude of the mismatch between the off-market price and market price.

One practical application of this invention is in the pricing of individual-to-group rare event risk management contracts where the group's resources are used to compensate group members who suffer the rare defined event in a defined time period. Rather than attempt to rely of historical data and actuarial assessments of the fair market price for each risk contract, the group can choose to allow members to set their own price (premium) for their defined contract. The total amount of premiums paid by all members defines the total available funds available for settling claims.

Soon after the expiry time for making and validating claims the total number of valid claims and total claim amount is also known. At this point in time an objective fair market price can be determined retrospectively from the actual claims. Specifically, the number of actual claims can be used to define the probability of the rare event in the defined period. If the total amount of premiums collected is less than the total amount claimed, then there is a shortfall in funds available. This means not all claims can be satisfied in full or no claims are satisfied in full. In a preferred embodiment, group-to-member payout rules are defined such that claimants who overpaid relative to the determined fair market price: (i) lose a defined portion of the excess premium they paid; but (ii) receive a higher percentage payout of their claim relative to claimants who paid less than the retrospectively determined fair market price. Claimants who underpaid are penalised by receiving a lesser percentage payout of their claims. Such penalties for over or under payment of the premium provide an incentive to pay just the right amount. When many people participant in such a one side market the average of normalized premiums paid (“normalized” meaning [contract premium]/[maximum claim value defined in the contract]) defines a fair market price for a unit value contract.

By way of explanation, consider two cases: (1) where there is shortfall of funds; and (2) sufficient funds were collected to cover all claims.

### Shortfall of Funds Example.

An example penalty formula for over payment is no refund for excess payments and the same percentage claim payout as on-the-money claimants (that is claimants who paid the determined fair market price). An example penalty formula for under payment that is off-market-claimants, is a smaller percentage claim payout than on-the-money claimants, where the fraction of the claim amount paid relative to the on-the-money claims is the (actual premium paid) / (fair market premium). For example if a claimant paid only half the retrospectively determined fair market premium then the percentage payout is only 50 per cent of the payout for the same contract with a retrospectively calculated fair market premium. Ideally the on-the-money claimants are paid the full claim amounts but this may not be possible of when total premiums paid is too low and also it may not be possible while also satisfying off-marketing claimants according to the selected off-market settlement payout rule. In these cases the on-the-money claimant payouts are adjusted downwards to ensure that the total amount paid in claim settlements matches the available funds collected from premiums paid after costs.

Sufficient funds example. All claims are settled and the excess is donated to charity or transferred in some manner to all members of the group equally.

Some embodiments make use of implied probability. If all contracts span the entire event period and the event probability is independent of the maximum claim amount then the implied probability PR is simply (total number of claims)/(by total number of contracts). In this example, a “contract” refers to a “risk contract as discussed further above. The retrospective fair market premium for a contract is PR x maximum claim value.

Some embodiments make use of disclosure of implied prices. More specifically, an example implementation is configured to disclose the implied value of the previous claim period in a contract purchase page, thereby to provide a reference point to new buyers. Future period event probabilities may vary according to seasonal and economic variables, which means the contemporaneous fair market price can be different from the recent history which may be useful for general baseline guidance. Another example implementation is configured to disclose to the buyer just prior to purchase the price of the anticipated contract implied from the purchases of similar contracts in a recent time period. Disclosure of contract prices implied from recent purchases creates a feedback mechanism similar to conventional two sided markets.

Peer Generated Trust Rating

Some embodiments provide technology configured to perform automated continuously updating generation of individual trust ratings based on a scoring system from members or peers in a defined group of individuals.

By way of example, consider a framework where group members exist in a networked group such as an online forum. An interface enables an operator to define the form of trust that is being rated (the trust topic), a trust scale (such as 0 to +10, where the highest rating represents the highest possible trustworthiness and a defined neutral value within the scale such as the mid-range value).

On joining the group a new member is assigned the defined neutral trust value.

Members are invited to use a voting interface to vote for any other member (target member) by assigning a value from the defined scale representing to voter's trust assessment of the target member (a trust vote. The vote table records for each trust vote, the database ID of the voter, the database ID of the target member, the time the vote was recorded (such as Julian time), the trust value selected by the voter which represents the voter's opinion of the trust value on the defined trust topic of the target member. Members can vote any time and re-vote for any member anytime. An alternative embodiment enables members to invite other members to give them a trust vote with an option to restrict all trust voting to invited members.

The voting records are continuously processed, or processed repeatedly a shortly spaced time intervals, to produce for each member a weighted average trust rating score but counting only the most recent vote each member received from each other member—that is, not counting more than one vote from each member and not counting superseded votes. The weighting value for each vote is defined as the current recorded assigned trust value of the member casting the vote. As each member's weighted trust value is computed, the member's trust value in the database is updated to reflect the new computed value. The new computed value is used in the next round of vote processing. This live feedback process combined with re-voting quickly establishes a peer to peer generated trust grading of each member on the defined topic.

Preferably, an interface is configured such that members cannot vote for themselves, and cannot see for whom other members have voted, or how they voted, or when they voted. Members can however see their own rated trust value. An alternative embodiment may use weighting values which are defined in a different trust voting forum deemed a more suitable measure of the reliability of the member's opinion in rating other members in the current forum.

It is apparent that the reliability of the assigned trust value for a member may depend also on the number of member votes used to compute it. Therefore a higher standard assigned trust value is produced by weighting each vote not only by the assigned trust value of the voter but also a further weighting factor Q related to the reliability of the trust value assigned to the voter. Q is assigned a value greater than 0 and less than or equal to 1. Voters who have been rated by the highest number of peers are assigned a Q value of 1 or close to 1. Voters who have been rated by a single peer are assigned the smallest Q values. One way to assign Q is Q=(Number of trust votes received by the voter)/(Highest number of trust votes received by any voter). Q can also be configured to favour more recent votes. A preferred embodiment makes use of the following assigned value formula:

M(i) i=1 to N=all members who trust voted for member M(j)

MR(i)=Trust rating value M(i) assigned to M(j)

MT(i)=assigned trust value for M(i)

Q(i)=trust value reliability factor: greater than 0 less than 1

Assigned Trust Value for M(j)=Sum{MR(i)×MT(i)×Q(i)}/Sum{MT(i)×Q(i)}

One possible practical application for this invention is in the automated assessment of insurance type claims. Claimants with trust values higher than an assigned threshold may be granted automatic acceptance of claims. Another application could be a peer voted assessment of the validity of claims. In this case the decision to accept or decline the claim can be determined by a weighted average of peer votes where the weighting value for each voter is the member's most recent assigned trust value.

There are of course broader applications, for example in the context of assigning credit ratings, skill levels in a trade/profession etc, rating competencies of service providers, and so on.

### Exemplary Applications

The technology described above is particularly useful in the context of enabling end users to create and participate in insurance arrangements without the need to engage a commercial service provider. For example, a Group Controller user decides to start a new group for a particular form of insurance, using desired rules. This becomes available to a plurality of further users, who in effect are brought together to self-generate a fund to handle claims.

### Exemplary Client-Server Framework

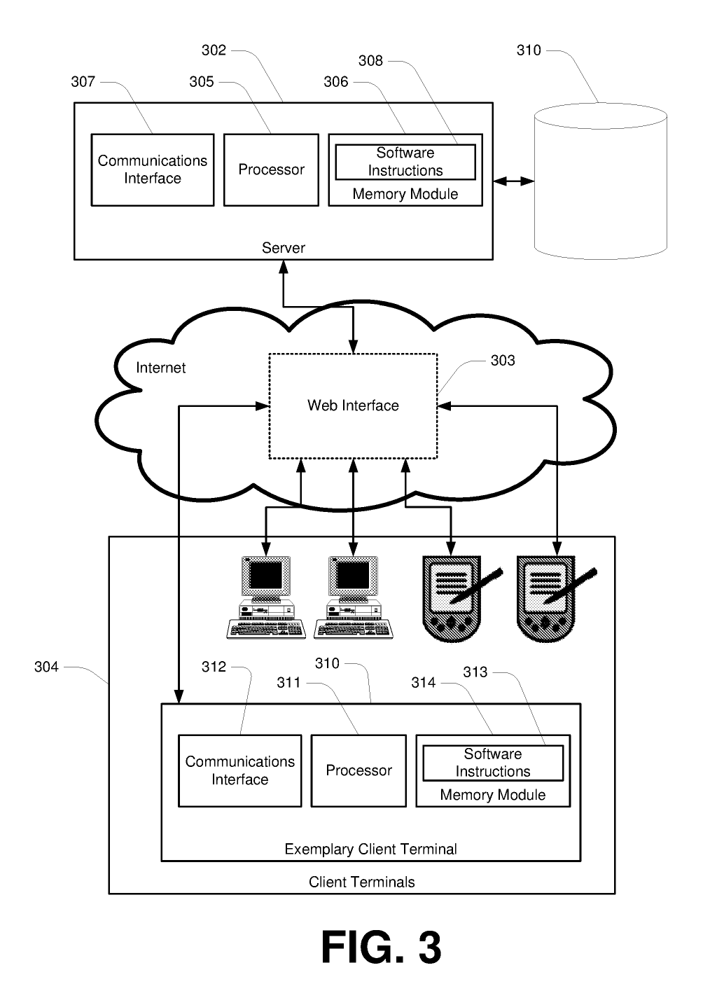

In some embodiments, methods and functionalities considered herein are implemented by way of a server, as illustrated in FIG. 3. In overview, a web server 302 provides a web interface 303. This web interface is accessed by the parties by way of client terminals 304. In overview, users access interface 303 over the Internet by way of client terminals 304, which in various embodiments include the likes of personal computers, PDAs, cellular telephones, gaming consoles, and other Internet enabled devices.

Server 303 includes a processor 305 coupled to a memory module 306 and a communications interface 307, such as an Internet connection, modem, Ethernet port, wireless network card, serial port, or the like. In other embodiments distributed resources are used. For example, in one embodiment server 302 includes a plurality of distributed servers having respective storage, processing and communications resources. Memory module 306 includes software instructions 308, which are executable on processor 305.

Server 302 is coupled to a database 310. In further embodiments the database leverages memory module 306.

In some embodiments web interface 303 includes a website. The term “website” should be read broadly to cover substantially any source of information accessible over the Internet or another communications network (such as WAN, LAN or WLAN) via a browser application running on a client terminal. In some embodiments, a website is a source of information made available by a server and accessible over the Internet by a web-browser application running on a client terminal. The web-browser application downloads code, such as HTML code, from the server. This code is executable through the web-browser on the client terminal for providing a graphical and often interactive representation of the website on the client terminal. By way of the web-browser application, a user of the client terminal is able to navigate between and throughout various web pages provided by the website, and access various functionalities that are provided.

Although some embodiments make use of a website/browser-based implementation, in other embodiments proprietary software methods are implemented as an alternative. For example, in such embodiments client terminals 304 maintain software instructions for a computer program product that essentially provides access to a portal via which framework 100 is accessed (for instance via an iPhone app or the like).

In general terms, each terminal 304 includes a processor 311 coupled to a memory module 313 and a communications interface 312, such as an internet connection, modem, Ethernet port, serial port, or the like. Memory module 313 includes software instructions 314, which are executable on processor 311. These software instructions allow terminal 304 to execute a software application, such as a proprietary application or web browser application and thereby render on-screen a user interface and allow communication with server 302. This user interface allows for the creation, viewing and administration of profiles, access to the internal communications interface, and various other functionalities.

### Interpretation

Unless specifically stated otherwise, as apparent from the following discussions, it is appreciated that throughout the specification discussions utilizing terms such as “processing,” “computing,” “calculating,” “determining”, analyzing” or the like, refer to the action and/or processes of a computer or computing system, or similar electronic computing device, that manipulate and/or transform data represented as physical, such as electronic, quantities into other data similarly represented as physical quantities.

In a similar manner, the term “processor” may refer to any device or portion of a device that processes electronic data, e.g., from registers and/or memory to transform that electronic data into other electronic data that, e.g., may be stored in registers and/or memory. A “computer” or a “computing machine” or a “computing platform” may include one or more processors.

The methodologies described herein are, in one embodiment, performable by one or more processors that accept computer-readable (also called machine-readable) code containing a set of instructions that when executed by one or more of the processors carry out at least one of the methods described herein. Any processor capable of executing a set of instructions (sequential or otherwise) that specify actions to be taken are included. Thus, one example is a typical processing system that includes one or more processors. Each processor may include one or more of a CPU, a graphics processing unit, and a programmable DSP unit. The processing system further may include a memory subsystem including main RAM and/or a static RAM, and/or ROM. A bus subsystem may be included for communicating between the components. The processing system further may be a distributed processing system with processors coupled by a network. If the processing system requires a display, such a display may be included, e.g., a liquid crystal display (LCD) or a cathode ray tube (CRT) display. If manual data entry is required, the processing system also includes an input device such as one or more of an alphanumeric input unit such as a keyboard, a pointing control device such as a mouse, and so forth. The term memory unit as used herein, if clear from the context and unless explicitly stated otherwise, also encompasses a storage system such as a disk drive unit. The processing system in some configurations may include a sound output device, and a network interface device. The memory subsystem thus includes a computer-readable carrier medium that carries computer-readable code (e.g., software) including a set of instructions to cause performing, when executed by one or more processors, one of more of the methods described herein. Note that when the method includes several elements, e.g., several steps, no ordering of such elements is implied, unless specifically stated. The software may reside in the hard disk, or may also reside, completely or at least partially, within the RAM and/or within the processor during execution thereof by the computer system. Thus, the memory and the processor also constitute computer-readable carrier medium carrying computer-readable code.

Furthermore, a computer-readable carrier medium may form, or be included in a computer program product.

In alternative embodiments, the one or more processors operate as a standalone device or may be connected, e.g., networked to other processor(s), in a networked deployment, the one or more processors may operate in the capacity of a server or a user machine in server-user network environment, or as a peer machine in a peer-to-peer or distributed network environment. The one or more processors may form a personal computer (PC), a tablet PC, a set-top box (STB), a Personal Digital Assistant (PDA), a cellular telephone, a web appliance, a network router, switch or bridge, or any machine capable of executing a set of instructions (sequential or otherwise) that specify actions to be taken by that machine.

Note that while diagrams only show a single processor and a single memory that carries the computer-readable code, those in the art will understand that many of the components described above are included, but not explicitly shown or described in order not to obscure the inventive aspect. For example, while only a single machine is illustrated, the term “machine” shall also be taken to include any collection of machines that individually or jointly execute a set (or multiple sets) of instructions to perform any one or more of the methodologies discussed herein.

Thus, one embodiment of each of the methods described herein is in the form of a computer-readable carrier medium carrying a set of instructions, e.g., a computer program that is for execution on one or more processors, e.g., one or more processors that are part of web server arrangement. Thus, as will be appreciated by those skilled in the art, embodiments of the present invention may be embodied as a method, an apparatus such as a special purpose apparatus, an apparatus such as a data processing system, or a computer-readable carrier medium, e.g., a computer program product. The computer-readable carrier medium carries computer readable code including a set of instructions that when executed on one or more processors cause the processor or processors to implement a method. Accordingly, aspects of the present invention may take the form of a method, an entirely hardware embodiment, an entirely software embodiment or an embodiment combining software and hardware aspects. Furthermore, the present invention may take the form of carrier medium (e.g., a computer program product on a computer-readable storage medium) carrying computer-readable program code embodied in the medium.

The software may further be transmitted or received over a network via a network interface device. While the carrier medium is shown in an exemplary embodiment to be a single medium, the term “carrier medium” should be taken to include a single medium or multiple media (e.g., a centralized or distributed database, and/or associated caches and servers) that store the one or more sets of instructions. The term “carrier medium” shall also be taken to include any medium that is capable of storing, encoding or carrying a set of instructions for execution by one or more of the processors and that cause the one or more processors to perform any one or more of the methodologies of the present invention. A carrier medium may take many forms, including but not limited to, non-volatile media, volatile media, and transmission media. Non-volatile media includes, for example, optical, magnetic disks, and magneto-optical disks. Volatile media includes dynamic memory, such as main memory. Transmission media includes coaxial cables, copper wire and fiber optics, including the wires that comprise a bus subsystem. Transmission media also may also take the form of acoustic or light waves, such as those generated during radio wave and infrared data communications. For example, the term “carrier medium” shall accordingly be taken to included, but not be limited to, solid-state memories, a computer product embodied in optical and magnetic media; a medium bearing a propagated signal detectable by at least one processor of one or more processors and representing a set of instructions that, when executed, implement a method; and a transmission medium in a network bearing a propagated signal detectable by at least one processor of the one or more processors and representing the set of instructions.

It will be understood that the steps of methods discussed are performed in one embodiment by an appropriate processor (or processors) of a processing (i.e., computer) system executing instructions (computer-readable code) stored in storage. It will also be understood that the invention is not limited to any particular implementation or programming technique and that the invention may be implemented using any appropriate techniques for implementing the functionality described herein. The invention is not limited to any particular programming language or operating system.

It should be appreciated that in the above description of exemplary embodiments of the invention, various features of the invention are sometimes grouped together in a single embodiment, FIG., or description thereof for the purpose of streamlining the disclosure and aiding in the understanding of one or more of the various inventive aspects. This method of disclosure, however, is not to be interpreted as reflecting an intention that the claimed invention requires more features than are expressly recited in each claim. Rather, as the following claims reflect, inventive aspects lie in less than all features of a single foregoing disclosed embodiment. Thus, the claims following the Detailed Description are hereby expressly incorporated into this Detailed Description, with each claim standing on its own as a separate embodiment of this invention.

Furthermore, while some embodiments described herein include some but not other features included in other embodiments, combinations of features of different embodiments are meant to be within the scope of the invention, and form different embodiments, as would be understood by those skilled in the art. For example, in the following claims, any of the claimed embodiments can be used in any combination.

Furthermore, some of the embodiments are described herein as a method or combination of elements of a method that can be implemented by a processor of a computer system or by other means of carrying out the function. Thus, a processor with the necessary instructions for carrying out such a method or element of a method forms a means for carrying out the method or element of a method. Furthermore, an element described herein of an apparatus embodiment is an example of a means for carrying out the function performed by the element for the purpose of carrying out the invention.

In the description provided herein, numerous specific details are set forth. However, it is understood that embodiments of the invention may be practiced without these specific details. In other instances, well-known methods, structures and techniques have not been shown in detail in order not to obscure an understanding of this description.

Similarly, it is to be noticed that the term coupled, when used in the claims, should not be interpreted as being limited to direct connections only. The terms “coupled” and “connected,” along with their derivatives, may be used. It should be understood that these terms are not intended as synonyms for each other. Thus, the scope of the expression a device A coupled to a device B should not be limited to devices or systems wherein an output of device A is directly connected to an input of device B. It means that there exists a path between an output of A and an input of B which may be a path including other devices or means. “Coupled” may mean that two or more elements are either in direct physical or electrical contact, or that two or more elements are not in direct contact with each other but yet still co-operate or interact with each other.

Thus, while there has been described what are believed to be the preferred embodiments of the invention, those skilled in the art will recognize that other and further modifications may be made thereto without departing from the spirit of the invention, and it is intended to claim all such changes and modifications as falling within the scope of the invention. For example, any formulas given above are merely representative of procedures that may be used. Functionality may be added or deleted from the block diagrams and operations may be interchanged among functional blocks. Steps may be added or deleted to methods described within the scope of the present invention.

1. A computer system configured to enable streamlined user-configuration of complex autonomous peer-to-peer transaction frameworks, and cause autonomous management of such frameworks, the system including:
a group generation interface that is configured to enable a group controller user to define a new group, wherein the group generation interface is accessed by the group controller user via a user interface rendered at a client terminal operated by the group controller user, wherein defining data representative of the new group includes accessing a rule generation interface thereby to define a plurality of rules;
a rule generation interface that is configured to enable the group controller user to define rules for the new group, wherein rule generation interface is accessed by the group controller user via a user interface rendered at a client terminal operated by the group controller user, wherein the rule generation interface enables the group control user to access, select, and customise a plurality of rule templates thereby to define a plurality of rules, wherein the plurality of rules include:
(i) participation eligibility rules, which define computer-verifiable conditions for a given user to be accepted as a group participant;
(ii) member-to-group payment rules, wherein the member-to-group payment rules define rules for triggering and/or verifying electronic transactions from a given group participant to a defined monitorable electronic funds management service; and
(iii) group-to-member payment rules, wherein the group-to-member payment rules define rules for digitally verifying real-world events, determining payment values, and triggering electronic transactions to a given group participant;
a data management subsystem that is configured to manage a database that maintains records representative of the groups defined via the group generation interface;
an implementation subsystem that is configured to monitor for a set of predefined events defined by the rules, and in response to observance of a given one of the predefined events, trigger a process based on one or more of the rules, wherein the implementation subsystem is configured to provide:
(i) a member-to-group transaction interface that is configured to trigger and verify periodic payments for each group participant to the group in accordance with the member-to-group payment rules for the group; and
(ii) a claim determination interface that is configured to receive, via a user interface accessed by a given participant user, a claim request associated with the given participant user and a group in which that participant user participates, wherein the claim determination interface is configured to cause execution of a claim determination process in respect of the claim request based on the group-to-member payment rules for the associated group.

2. A system according to claim 1 including a group access interface that is configured to enable a participant user to view data representative of a plurality of groups defined by group controller users, and selectively provide a participation request associated with selected one of the groups, wherein the group access interface is accessed by the participant user via a user interface rendered at a client terminal operated by the participant user;

3. A system according to claim 2 including a participation approval module that is configured to process a plurality of participation requests from participant users, wherein each participation request is associated with: (i) a particular participant user associated with a unique participant user record; and (ii) a particular group; and wherein the participation approval module is configured to make an approval determination for a given participation request based upon processing of the participant user record associated with the particular user and the participation eligibility rules for the particular group;

4. A system according to claim 1 wherein the rule generation interface is configured to enable the group controller user to define member-to-group payment rules, wherein the member to group payment rules include a rule to set a participation unit cost based on a group participant vote.

5. A system according to claim 1 wherein the participation eligibility rules include a rule defining a threshold level of member-member endorsement required for participation in a given group.

6. A system according to claim 5 wherein a group controller endorses a first group of members, and further members are endorsed via a chained member-member endorsement process originating from the first group of members.

7. A system according to claim 6 including maintaining a record of member-member endorsements.

8. A system according to claim 1 wherein the member-to-group payment rules include rules for determining a cost for participation in the group.

9. A system according to claim 8 wherein the rules for determining a cost for participation in the group enable any one or more of: (i) a mathematical formula defined by a group controller; (ii) a formula defined by a vote; and (iii) a rule defined by the history of claims for similar groups.

10. A system according to claim 1 wherein the member-to-group payment rules include a rule enabling periodic payments.

11. A system according to claim 10 wherein the periodic payments are dynamically defined based on claim amounts during a defined period.

12. A system according to claim 1 wherein the group-to-member payment rules include rules enabling utilising one or more third party assessors.

13. A system according to claim 1 wherein the group-to-member payment rules include one or more of: rules requiring publication in a defined manner of a defined market event; rules requiring publication in a defined manner of defined natural event; and rules requiring trust-based claim validation via member-member endorsement.

14. A system according to claim 1 wherein the group-to-member payment rules include rules enabling a vote of all or a subset of group participants to approve/reject a given claim request.

15. A system according to claim 1 wherein the group-to-member payment rules include rules defining a protocol for managing inequality between: (i) a value associated claim fund derived from member-to-group payments; and (ii) a value associated with claim requests.

16. A system according to claim 17 wherein a given rule enables re-insurance to cover a shortfall in the claim fund derived from member-to-group payments based on a value associated with claim requests.

17. A system according to claim 1 wherein participation of a user in a given group is defined by association of one or more participation units to that member.

18. A system according to any preceding claim 1 including a group merge module, wherein the group merge module is configured to enable merging a first group and a second group, wherein: the first group has a first time bucket definition; the second group has a second different time bucket definition that is an integral multiple of the first time bucket definition; and wherein the merging include transitioning to a common time bucket definition.

19. A system according to claim 1 wherein the rule generation interface is configured to enable defining of a member-to-group payment rules based on a one sided market driven risk pricing mechanism.

20. A system according to claim 1 wherein the rule generation interface is configured to enable defining of a group-to-member payment rules that enable automated approval of group-to-member payments based on a participant trust value derived from a participant voting process.

21. A computer implemented method, performed by one or more server devices, configured to enable user-driven formation and implementation of community funded insurance arrangements, the method including:
providing a group generation interface that is configured to enable a group controller user to define a new group, wherein the group generation interface is accessed by the group controller user via a user interface rendered at a client terminal operated by the group controller user, wherein defining data representative of the new group includes accessing a rule generation interface thereby to define a plurality of rules including:
(i) participation eligibility rules for participation in a community funded insurance arrangement;
(ii) member-to-group payment rules, relating to insurance premiums; and
(iii) group-to-member payment rules, relating to insurance claims;
updating a database to maintain a record representative of the new group;
providing a group access interface that is configured to enable a participant user to view data representative of a plurality of groups defined by group controller users, and selectively provide a participation request associated with selected one of the groups, wherein the group access interface is accessed by the participant user via a user interface rendered at a client terminal operated by the participant user;
operating a participation approval module that is configured to process a plurality of participation requests from participant users, wherein each participation request is associated with: (i) a particular participant user associated with a unique participant user record; and (ii) a particular group; and wherein the participation approval module is configured to make an approval determination for a given participation request based upon processing of the participant user record associated with the particular user and the participation eligibility rules for the particular group;
providing member-to-group payment interface that is configured to enable a given participant user to, following a positive approval determination, provide electronic payment of an insurance premium in accordance with the member-to-group payment rules for the group in respect of which the positive approval determination is made; and
providing a claim determination interface that is configured to receive, via a user interface accessed by a given participant user, a claim request associated with the given participant user and a group in which that participant user participates, wherein the claim determination interface is configured to perform a claim determination process in respect of the claim request based on the group-to-member payment rules for the associated group.

22. A method according to claim 21 wherein the participation eligibility rules include a rule defining a threshold level of member-member endorsement required for participation in a given group.

23. A method according to claim 22 wherein a group controller endorses a first group of members, and further members are endorsed via a chained member-member member endorsement process originating from the first group of members.

24. A method according to claim 23 including maintaining a record of member-member endorsements.

25. A method according to claim 21 wherein the member-to-group payment rules include rules for determining a cost for participation in the group.

26. A method according to claim 25 wherein the rules for determining a cost for participation in the group enable any one or more of: (i) a mathematical formula defined by a group controller; (ii) a formula defined by a vote; and (iii) a rule defined by the history of claims for similar groups.

27. A method according to claim 21 wherein the member-to-group payment rules include a rule enabling periodic payments.

28. A method according to claim 27 wherein the periodic payments are dynamically defined based on claim amounts during a defined period.

29. A method according to claim 21 wherein the group-to-member payment rules include rules enabling utilising one or more third party assessors.

30. A method according to claim 21 wherein the group-to-member payment rules include
rules requiring publication in a defined manner of a defined market event.

31. A method according to claim 21 wherein the group-to-member payment rules include rules requiring publication in a defined manner of defined natural event.

32. A method according to claim 21 wherein the group-to-member payment rules include rules requiring trust-based claim validation via member-member endorsement.

33. A method according to claim 21 wherein the group-to-member payment rules include rules enabling a vote of all or a subset of group participants to approve/reject a given claim request.

34. A method according to claim 21 wherein the group-to-member payment rules include rules defining a protocol for managing inequality between: (i) a value associated claim fund derived from member-to-group payments; and (ii) a value associated with claim requests.

35. A method according to claim 24 wherein a given rule enables re-insurance to cover a shortfall in the claim fund derived from member-to-group payments based on a value associated with claim requests.

36. A method according to claim 21 wherein participation of a user in a given group is defined by association of one or more participation units to that member.

37. A computer implemented method, performed by one or more server devices, configured to enable generation and management of group structures, the method including: enabling users to create and/or join groups, wherein each group is associated with rules defining member-to-group payments to provide a claim fund and rules defining group-to-member payments that are claims against the claim fund.

38. A computer system configured to perform a method according to claim 21.

39. A computer program configured to perform a method according to any one of claim 21.

40. A non-transitory carrier medium carrying computer executable code that, when executed on a processor, causes the processor to perform a method according to any one of claim 21.

41. (canceled)
